(19) United States
(12) Patent Application Publication
(10) Pub. No.: US 2018/0162208 A1
(43) Pub. Date: Jun. 14, 2018

(54) WEATHER STRIP FOR VEHICLE AND METHOD FOR MANUFACTURING THE SAME

(71) Applicant: Hyundai Motor Company, Seoul (KR)

(72) Inventors: Gyeong Wan JO, Jinju-si (KR); Chang Yeol YOO, Suwon-si (KR)

(73) Assignee: Hyundai Motor Company, Seoul (KR)

(21) Appl. No.: 15/598,888

(22) Filed: May 18, 2017

(30) Foreign Application Priority Data
Dec. 12, 2016 (KR) 10-2016-0168788

(51) Int. Cl. B60J 10/18; B60J 10/16; B60J 10/26; B60J 10/00; B60J 10/21; B60J 10/24

(52) U.S. Cl. CPC B60J 10/18; B60J 10/16; B60J 10/26; B60J 10/15; B60J 10/21; B60J 10/24; B60J 10/45

(57) ABSTRACT

A weather strip for a vehicle by which a bonding force between a metallic core and a weather strip of rubber may be reinforced, and a method for manufacturing the same, may include a weather strip body, and a metallic core inserted into the weather strip body, wherein the core has an uneven layer on a surface thereof.

### CROSS-REFERENCE TO RELATED APPLICATION

The present application claims priority to Korean Patent Application No. 10-2016-0168788, filed on Dec. 12, 2016, the entire contents of which is incorporated herein for all purposes by this reference.

### BACKGROUND OF THE INVENTION

### Field of the Invention

The present invention relates to a weather strip for a vehicle and a method for manufacturing the same, and more particularly to a weather strip for a vehicle by which a bonding force between a metallic core and a weather strip of rubber may be reinforced, and a method for manufacturing the same.

### Description of-Related Art

In general, a weather strip for a vehicle is disposed at a periphery of a door, a body, a door channel, a trunk lid, or the like to seal a vehicle internal and a trunk compartment to prevent external objects including external air, sounds, dust, raindrops, or snow from entering the vehicle internal and the trunk compartment, and also functions to absorb an impact when the door is closed or restrain vibration of the door trunk lid during driving of the vehicle.

The weather strip includes a body weather strip and a door weather strip, a glass run, a trunk lid, and a backdoor weather strip, and they are disposed between a body side and a door frame to absorb an impact or prevent foreign substances from entering the internal of the vehicle when a door is closed.

The weather strip includes a weather strip body of rubber and a metallic core inserted into the weather strip body.

Meanwhile, according to the conventional method for manufacturing a weather strip, after an adhesive including Chemlok® is applied on a surface of the core, the weather strip body and the metallic core are simultaneously extruded.

However, in a high temperature area (deserts, South-East Asia, or the like), the rubber material of the weather strip body may be hardened due to the deterioration of the adhesive or the performance of the weather strip body may be lowered.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a weather strip for a vehicle, by which a bonding force between a core and a weather strip body may be reinforced by forming an uneven layer on a surface of the core, and a method for manufacturing the same.

The technical objects of the present invention are not limited to the above-mentioned one, and the other unmentioned technical objects will become apparent to those skilled in the art from the following description.

In accordance with an aspect of the present invention, there is provided a weather strip for a vehicle, the weather strip including a weather strip body, and a metallic core inserted into the weather strip body, wherein the core has an uneven layer on a surface thereof.

In accordance with another aspect of the present invention, there is provided a method for manufacturing a weather strip for a vehicle, the method including (1) preparing a core, (2) forming a uneven layer on a surface of the core, and (3) inserting the core into the weather strip body.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a sectional view illustrating a weather strip according to an exemplary embodiment of the present invention;

FIG. 2 is a view illustrating a surface of the weather strip according to the exemplary embodiment of the present invention;

FIG. 3 is a flowchart illustrating a method for manufacturing a weather strip according to an exemplary embodiment of the present invention;

FIG. 4 is a graph depicting a comparison result of percent elongations (%) to bonding strengths for an exemplary embodiment of the present invention and the related art; and

FIG. 5 is a graph depicting a comparison result of high-temperature exposure times (min) to bonding strengths for an exemplary embodiment of the present invention and the related art.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is intended to cover not only the exemplary embodiments, but also various alternatives, modifications, equivalents and other embodiments, which may be included within the spirit and scope of the invention as defined by the appended claims.

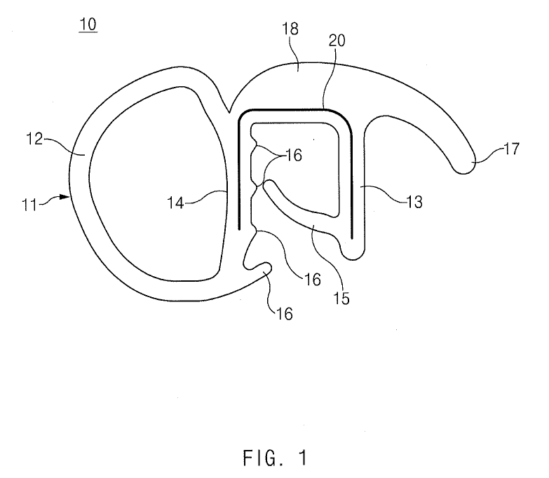

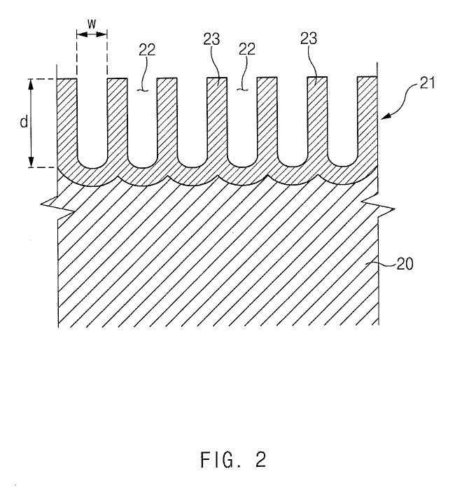

Referring to FIG. 1 and FIG. 2, a weather strip 10 according to an exemplary embodiment of the present invention may include a weather strip body 11, and a metallic core 20 inserted into the weather strip body 11.

The weather strip body 11 may be formed of a material including rubber, ethylene propylene diene copolymer (EPDM) rubber, or a synthetic resin.

The weather strip body 11 may be disposed in flanges of various panels.

As illustrated in FIG. 1, the weather strip body 11 may have a sealing part 12 formed on one side thereof, and the sealing part 12 may be hollow.

The weather strip body 11 may have a first side wall 13 and a second side wall 14 on an opposite side thereof such that the first side wall 13 and the second side wall 14 face each other, and the first side wall 13 and the second side wall 14 may be connected to each other by a connection portion 18.

At least one first lip 15 protrudes from the first side wall 13 towards the second side wall 14, at least one second lip 16 protrudes from the second side wall 14 towards the first side wall 13, and a third lip 17 protrudes from one side of the connection portion 18.

According to an exemplary embodiment of the present invention, the body and the shape of the weather strip body 11 are not limited to the structure illustrated in FIG. 1, but the weather strip body 11 may have various shapes and structures.

As illustrated in FIG. 2, the metallic core 20 may have an uneven layer 21 of a specific thickness on a surface thereof. The uneven layer 21 of the core 20 may be formed through an anodizing process, a hairline process, or the like.

Referring to FIG. 2, the uneven layer 21 of the core 20 may have a plurality of pores 22 and a plurality of bosses 23 formed through an anodizing process, a hairline process, or the like.

As the material of the weather strip body 11 is inserted into the plurality of pores 22 of the core 20 through a forming process including co-extrusion or co-injection molding, an attaching performance of the weather strip body 11 to the core 20 may be improved and the weather body 11 may be coupled to a surface of the core 20 by a strong bonding force.

For example, the width w of the pores 22 may greater than 0 μm and less than 5 μm, and the depth d of the pores 22 may be 0.1 μm to 1.0 μm.

According to an exemplary embodiment of the present invention, the core 20 may be formed of a material including aluminum, titanium, or magnesium, which may be anodized, and accordingly, the uneven layer 21 of the core 20 may be formed through an anodizing process.

In this way, according to the exemplary embodiment of the present invention, as the core 20 is formed of an anodized material including aluminum, titanium, or magnesium, the weight of the core 20 may be remarkably reduced as compared with the conventional weather strip including a core of steel and accordingly, the vehicle may be light-weighted and the fuel ratio of the vehicle may be improved.

For example, the anodizing process for forming the uneven layer 21 of the core 20 may be performed in a condition of a voltage of DC 12 to 20 V, a temperature of 18 to 25° C., and an oxidation time of 20 to 30 min by use of an electrolyte including 18% of sulfuric acid and 5% of oxalic acid.

According to another exemplary embodiment of the present invention, the core 20 may be formed of a material that is similar to or the same as the material of the conventional core including steel, and accordingly, the uneven layer 21 of the core 20 may be formed through a hairline process.

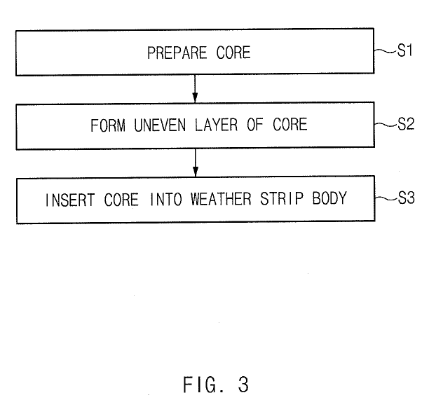

FIG. 3 is a flowchart illustrating a method for manufacturing a weather strip according to an exemplary embodiment of the present invention.

Referring to FIG. 3, a core 20 having a U-shaped cross-section and a specific length is prepared (S1). Then, after the core 20 is cut to a specific length, a surface of the core 20 is polished and the polished surface of the core 20 may be washed by use of distilled water.

Thereafter, an uneven layer 21 is formed on the surface of the core 20 through an anodizing process or a hairline process (S2).

According to the embodiment, the uneven layer 21 of the core 20 may be formed through an anodizing process. For example, the anodizing process may be performed in a condition of a voltage of DC 12 to 20 V, a temperature of 18 to 25° C., and an oxidation time of 20 to 30 min by use of an electrolyte including 18% of sulfuric acid and 5% of oxalic acid.

According to another exemplary embodiment, the uneven layer 21 of the core 20 may be formed through a hairline process. Here, in the hairline process, the uneven layer 21 may be formed by forming a hairline of various patterns on the surface of the core 20 by use of a metal brush.

A weather strip 10 may be formed by inserting the core 20 having the uneven layer 21 into the weather strip body 11 through a forming process including co-extrusion or co-injection molding (S3).

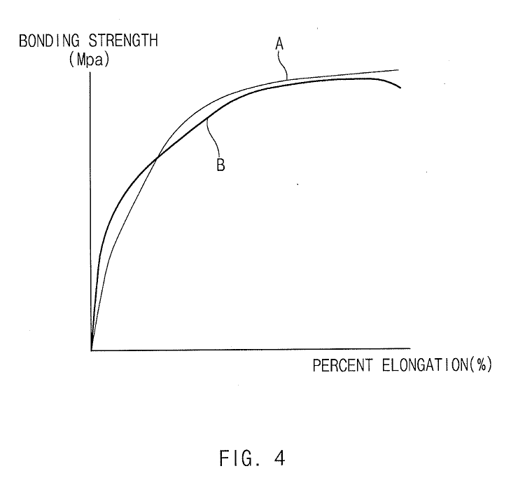

FIG. 4 is a graph depicting a comparison result of percent elongations (%) to bonding strengths for an exemplary embodiment of the present invention and the related art.

Referring to FIG. 4, it can be seen that the percent elongation (%) of the conventional weather strip (refer to line B) increases such that the bonding strength thereof rapidly decreases at a specific point but the bonding strength of the weather strip remains constant even though the percent elongation (%) of the weather strip (refer to line A) according to an exemplary embodiment of the present invention increases.

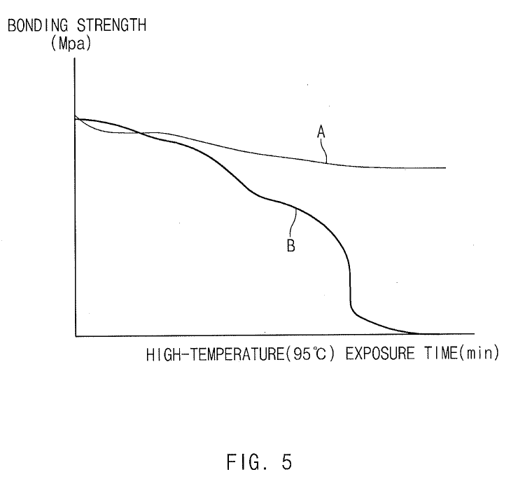

FIG. 5 is a graph depicting a comparison result of high-temperature exposure times (min) to bonding strengths for an exemplary embodiment of the present invention and the related art.

Referring to FIG. 5, it can be seen that the bonding strength of the conventional weather strip (refer to line B) rapidly decreases when the weather strip is exposed to a high temperature (approximately 95° C.) for a long time period but the bonding strength of the weather strip (refer to line A) remains constant even though the weather strip is exposed to a high temperature (approximately 95° C.) for a long time period.

According to an exemplary embodiment of the present invention, because the weather strip body of rubber may be firmly bonded to the uneven layer of the core when the core and the weather strip body are formed through co-injection molding after the uneven layer is formed on the surface of the metallic core of by applying an anodizing process or a hairline process, a bonding force between the weather strip body and the core may be reinforced, and accordingly, the high-temperature durability of the weather strip may be increased and the weather strip body may be continuously bonded to the surface of the core.

Further, because the weather strip body may be firmly bonded to the uneven layer of the core when the core and the weather strip body are formed through co-injection molding, it is unnecessary to apply a separate adhesive and accordingly, a process time may be remarkably shortened.

Further, according to the exemplary embodiment of the present invention, as the core is formed of an anodized material including aluminum, titanium, or magnesium, the weight of the core 20 may be remarkably reduced as compared with the conventional weather strip including a core of steel and accordingly, the vehicle may be light-weighted and the fuel ratio of the vehicle may be improved.

For convenience in explanation and accurate definition in the appended claims, the terms “upper”, “lower”, “internal”, “outer”, “up”, “down”, “upper”, “lower”, “upwards”, “downwards”, “front”, “rear”, “back”, “inside”, “outside”, “inwardly”, “outwardly”, “internal”, “external”, “internal”, “outer”, “forwards”, and “backwards” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described to explain certain principles of the invention and their practical application, to enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A weather strip for a vehicle, the weather strip comprising:
a weather strip body; and
a metallic core inserted into the weather strip body,
wherein the core has an uneven layer on a surface thereof.

2. The weather strip of claim 1, wherein the uneven layer is formed through an anodizing process or a hairline process.

3. A method for manufacturing a weather strip for a vehicle, the method including:
(1) preparing a core;
(2) forming a uneven layer on a surface of the core; and
(3) inserting the core into a weather strip body.

4. The method of claim 3, wherein in (2), the uneven layer is formed through an anodizing process or a hairline process.

5. The method of claim 3, wherein in (3), the core having the uneven layer is inserted into the weather strip body through co-extrusion or co-injection molding.
